(19) United States
(12) Patent Application Publication
(10) Pub. No.: US 2026/0111877 A1
(43) Pub. Date: Apr. 23, 2026

(54) SYSTEMS AND METHODS FOR A MULTIDIMENSIONAL IDENTITY PROTOCOL

(71) Applicant: Self ID, Inc., Wilmington, DE (US)

(72) Inventors: Craig Christopher Sellars, San Juan, PR (US); David McFadzean, Toronto (CA); Christian Saucier, Seneca, SC (US)

(73) Assignee: Self ID, Inc., Wilmington, DE (US)

(21) Appl. No.: 19/367,360

(22) Filed: Oct. 23, 2025

Related U.S. Application Data
(60) Provisional application No. 63/710,758, filed on Oct. 23, 2024.

(51) Int. Cl. G06Q 20/36; G06Q 20/38

(52) U.S. Cl. CPC G06Q 20/3674; G06Q 20/3825; G06Q 20/3829

(57) ABSTRACT

Systems and methods for implementing a multidimensional identity protocol (MDIP) are disclosed. The techniques described herein can include establishing an MDIP method of a decentralized identifier (DID) specification. The MDIP DID method can be used to provide a peer-to-peer identity layer with secure decentralized verifiable credentials. The MDIP can be used to create a DID anchored to a CAS. The DID can include at least a portion of a unique identifier provided by the CAS and derived from an MDIP DID create operation for a document. The MDIP can be used to register the DID on a decentralized registry. The registered DID can identify a pointer to the document in the CAS. Registered DIDs can be resolved via the MDIP to obtain the associated DID document.

### CROSS-REFERENCES TO RELATED APPLICATIONS

This application claims the benefit of and priority to U.S. Provisional Patent Application No. 63/710,758, filed Oct. 23, 2024, the contents of which is incorporated by reference herein in its entirety for all purposes.

### BACKGROUND

Traditional approaches for recording identity information rely on central entities that both maintain and handle requests for identity information. Such centralized entities inherently provide single points of failure that, if affected by a breach or outage, may compromise all user data maintained by the centralized entities.

### SUMMARY

The systems and methods of the present disclosure provide techniques for implementing a multidimensional identity protocol (MDIP). The approaches described herein provide a secure, peer-to-peer approach to creating, registering, and referencing decentralized identifiers (DIDs) and DID documents associated therewith. The protocol (hereafter MDIP) described herein implements a world wide web consortium (W3C)-compatible DID method, upon which W3C-compatible verifiable credential (VC) functionality layer is implemented. More particularly, the MDIP DID method specification conforms to the requirements specified in the DID specification currently published by the W3C Credentials Community Group and provides a peer to peer (P2P) identity layer with secure decentralized VCs recorded as DID documents. MDIP augments these standards with features and interfaces that facilitate multidimensional user-centric identity management. Examples of such features include publication of DID manifests, wallet and identity management, multi-registry support, backup and restore features, polling, schema management, among other features described herein.

DIDs implemented according to the techniques described herein can include agent DIDs and asset DIDs. Agent DIDs can be associated with corresponding public-private key pairs and can be controllers of asset DIDs, while asset DIDs can point to information or documents and are controlled by a single agent DID. Agent and asset DIDs created according to MDIP can be used to create, store, and manage verifiable credentials in a decentralized and secure manner. The DIDs created and managed via MDIP described herein provide self-sovereign control over digital identity, facilitating creation, management, and verification of identifiers and identity data without reliance on a central authority or computing system.

Asset DIDs implemented using MDIP can correspond to identity claims (e.g., age, residence, etc.) using verifiable credentials issued by any other identity on a network of MDIP gatekeeper systems. MDIP described herein enables the creation and public registration of fully decentralized and trustless identities using peer-to-peer ledger infrastructure. The DIDs implemented using MDIP can be registered on decentralized ledgers/blockchains like Bitcoin. When registered, the DID is evidenced on the ledger while associated document data is stored on a decentralized, peer-to-peer content-addressable storage repository. MDIP is registry and repository agnostic and may be implemented using any number of immutable or mutable registries and repositories. A DID registry mediator is implemented to monitor for and post new DIDs to the associated network. DID document distribution complements the decentralized registration process described above by providing a gossip protocol that rapidly disseminates a DID across a network of MDIP gatekeeper nodes. These and other technical improvements are described in further detail herein.

At least one other aspect relates to a method. The method can be performed, for example, by one or more processors coupled to non-transitory memory. The method can include establishing an MDIP method of a DID specification, the MDIP DID method configured to provide a peer-to-peer identity layer with secure decentralized verifiable credentials. The method can include creating a DID anchored to a content addressable storage (CAS), the DID comprising a part of a unique identifier provided by the CAS and derived from an MDIP DID create operation for a document. The method can include registering the DID on a decentralized registry, the DID identifying a pointer to the document of the DID in the CAS. The method can include receiving a request to resolve the DID.

In some implementations, the method can include anchoring the DID to the CAS prior to registering the DID on the decentralized registry. In some implementations, the document corresponding to the DID anchored in the CAS identifies the decentralized registry. In some implementations, the document associated with the DID comprises an indication of one of an agent or an asset. In some implementations, the document identifies a single agent as a controller. In some implementations, the asset does not have an associated public key.

In some implementations, the method can include providing the DID and the document to a distribution network to distribute the DID and the document across a plurality of MDIP nodes of a network without waiting for registration of the DID on the decentralized registry. In some implementations, the DID can be distributed to the plurality of MDIP nodes prior to completion of registration of the DID on the decentralized registry or faster than registration of the DID on the decentralized registry.

In some implementations, the method can include identifying, responsive to monitoring the decentralized registry, an update to the document associated with the DID, the decentralized registry storing for each update to the document a corresponding pointer to a corresponding version of the document in the CAS. In some implementations, creating the DID is decentralized through the CAS and an update to the document of a DID is decentralized through the decentralized registry. In some implementations, the DID can be identified as an agent DID, and the document can comprise a public key and specify the agent DID as a controller.

At least one aspect relates to a system. The system can include one or more processors coupled to memory. The system can identify a wallet for a multidimensional identity protocol, the wallet comprising a private key and a public key corresponding to the private key. The system can generate, using information of the wallet, an operation object to register a DID for the wallet in a decentralized registry, the operation object comprising the public key. The system can digitally sign the operation object using the private key. The system can provide the operation object to a gatekeeper system, causing the gatekeeper system to verify the operation object using the public key and record the DID in the decentralized registry.

In some implementations, the system can derive the private key and the public key in response to a request to generate the wallet. In some implementations, the operation object can identify one of a create operation, an update operation, or a delete operation.

At least one aspect relates to another system. The system can include one or more processors coupled to memory. The system can receive, from a keymaster system, an operation object to register a DID in a decentralized registry, the operation object comprising a public key and a digital signature purportedly generated using a private key corresponding to the public key. The system can verify the digital signature of the operation object using the public key. The system can update a decentralized registry based on the operation object to generate the DID. The system can provide the DID to the keymaster system in response to the operation object.

In some implementations, the system can derive the DID based on a content identifier of a CAS system. In some implementations, the system can monitor the decentralized registry to witness the DID.

At least one aspect relates to yet another system. The system can include one or more processors coupled to memory. The system can receive, from a keymaster system, a request to access a document stored in a decentralized registry, the request comprising a DID of the document. The system can retrieve anchor data identified by the DID from a database. The system can generate the document using information retrieved from a distributed registry identified in the anchor data. The system can provide the document in response to the request.

In some implementations, the system can generate the document based on at least one update document associated with the anchor data identified by the DID. In some implementations, the update document can indicate that the DID has been deleted.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects may also be implemented using any suitable apparatus, which may take the form of programmable computers running computer programs arranged to implement the aspect. As used in the specification and in the claims, the singular form of ‘a,’ ‘an,’ and ‘the’ include plural referents unless the context clearly dictates otherwise.

### BRIEF DESCRIPTION OF THE DRAWINGS

FIG. 1 illustrates a block diagram of an example system for implementing a multidimensional identity protocol (MDIP), in accordance with one or more implementations;

FIG. 2 illustrates an example diagram showing how decentralized identifier (DID) documents can be stored and referenced across one or more decentralized registries using an MDIP, in accordance with one or more implementations;

FIG. 3 illustrates a flowchart of an example method of generating one or more DIDs using a keymaster system implementing MDIP, in accordance with one or more implementations;

FIG. 4 illustrates a flowchart of an example method of recording one or more DIDs using a gatekeeper system implementing MDIP, in accordance with one or more implementations;

FIG. 5 illustrates a flowchart of an example method of resolving one or more DID documents using a gatekeeper system implementing MDIP, in accordance with one or more implementations;

FIG. 6 illustrates a flowchart of an example method of recording one or more DIDs to a decentralized ledger according to MDIP, in accordance with one or more implementations;

FIG. 7 illustrates a flowchart of an example method of creating DIDs according to MDIP, in accordance with one or more implementations; and

FIG. 8 illustrates a block diagram of a server system and a client computer system in accordance with an illustrative implementation.

### DETAILED DESCRIPTION

The systems and methods of the present disclosure provide techniques for implementing a multidimensional identity protocol (MDIP). MDIP is a decentralized and secure protocol for managing decentralized identifiers (DIDs) across various platforms and applications. DIDs serve as a persistent and verifiable identifier of an entity or document within the MDIP ecosystem. Cryptographic techniques, including asymmetric encryption and digital signatures, are implemented to ensure protocol security and information authenticity, preventing unauthorized modifications or impersonation of DIDs or DID documents.

MDIP is implemented using one or more keymaster clients in communication with a decentralized network of gatekeeper nodes. Each keymaster client is responsible for managing one MDIP wallet, which stores the private seed key associated with one or more DIDs. Each keymaster client can generate one or multiple public keys, one for each agent DID, which represent individual users, entities, or systems that interact using MDIP. Keymaster clients can use keys associated with an agent DID to digitally sign, encrypt, or decrypt information associated with the agent DID. Keymaster clients can also be used to generate asset DIDs, which represent any type of DID document that is controlled by a single agent DID, as well as perform verification of verified credentials (VCs) and verifiable presentations (VPs) to perform trustless authentication of entities. MDIP credential presentation and verification is performed using a challenge and response process constituted of MDIP operations that preserves an agent DID data privacy while enabling the presentation of cryptographically secure credentials to other agent DIDs.

Each keymaster client communicates with a gatekeeper node to perform MDIP operations. Gatekeeper nodes are responsible for managing and distributing DIDs and associated DID documents across the decentralized network, as well as verifying the authenticity of DID information provided by keymaster clients. DID information stored by a gatekeeper node can be distributed to the decentralized gatekeeper network using a swarming protocol. For example, when a new DID is created by a gatekeeper at the request of a keymaster client, data for the new DID is distributed among all connected gatekeepers, enabling efficient lookup and verification during subsequent MDIP operations. MDIP is agnostic to the distribution protocol and may be implemented using any combination of data distribution systems. In some implementations, the DIDs and associated DID documents are distributed using a data swarming protocol called Hyperswarm.

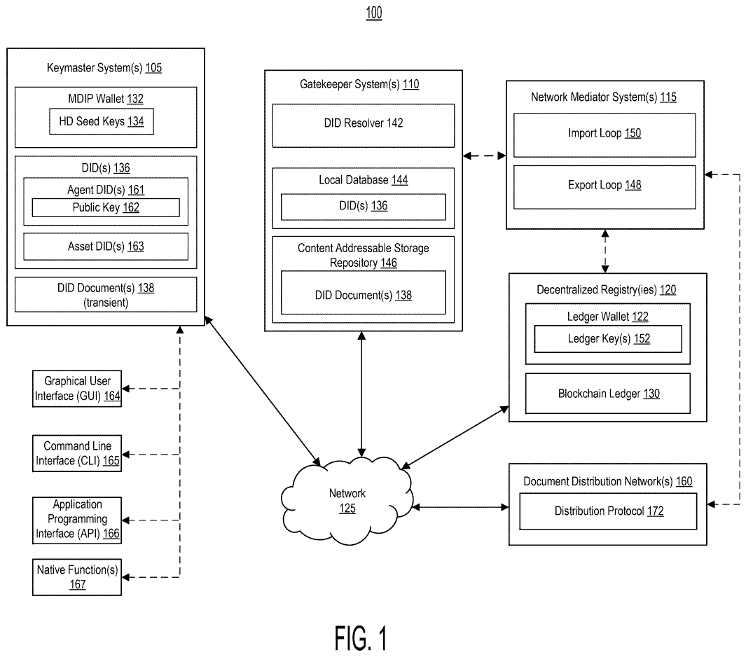

DIDs associated with DID documents created according to the techniques described herein are stored in a content addressable storage repository and registered in decentralized ledgers including blockchains by gatekeeper nodes. MDIP is registry agnostic and may be implemented using any combination of decentralized registries. Likewise, MDIP is repository agnostic and may be implemented using any content addressable storage system. The gatekeeper nodes can implement any number of network mediators to distribute and register DIDs using any number of decentralized networking technology, including but not limited to blockchain networks. Different network mediators may be implemented to register DID information on different blockchains. In such implementations, gatekeeper nodes can monitor transactions occurring on the blockchain to identify and locally store changes to DID-related information as witnessed on the independent blockchain network. An example system implementing MDIP and its associated operations is described in connection with FIG. 1.

Referring to FIG. 1, depicted is a block diagram of an example system that may be used to implement various operations of MDIP, in accordance with one or more implementations. The system 100 is shown as including one or more keymaster systems 105 (sometimes referred to herein as one or more “keymasters” or “keymaster clients”), one or more gatekeeper systems 110 (sometimes referred to herein as one or more “gatekeeper nodes 110”), one or more network mediator systems 115, at least one network 125, at least one decentralized registry 120, and at least one document distribution network 160. Although each computing system/component in FIG. 1 is shown as a singular element, it should be understood that multiple of any component, system, device, or data may be included in system 100 to perform any of the functionalities described herein.

The network 125 can include computer networks such as the Internet, local, wide, metro, or other area networks, intranets, satellite networks, other computer networks such as voice or data mobile phone communication networks, and combinations thereof. Any of the computing systems described herein (or components thereof) can communicate via the network 125. The network 125 may be any form of computer network that can relay information between different computing systems. The network 125 can include the Internet and/or other types of data networks, such as a local area network (LAN), a wide area network (WAN), a cellular network, a satellite network, or other types of data networks. The network 125 can include any number of computing devices (e.g., computers, servers, routers, network switches, etc.) that are configured to receive and/or transmit data within the network 125. The network 125 can further include any number of hardwired and/or wireless connections. Any or all of the computing devices described herein can communicate wirelessly (e.g., via Wi-Fi, cellular, radio, etc.) with a transceiver that is hardwired (e.g., via a fiber optic cable, a CAT5 cable, etc.) to other computing devices in the network 125. Any or all of the computing devices described herein can communicate wirelessly with the computing devices of the network 125 via a proxy device (e.g., a router, network switch, or gateway).

Each keymaster system 105 can be or include software, hardware, or any combination thereof. In some implementations, a keymaster system 105 may be a computing system that can access functionalities of MDIP by interacting with one or more gatekeeper systems 110. Each keymaster system 105 can include one or more processing circuits, which may include at least one processor and a memory (e.g., non-transitory memory). The memory can store processor-executable instructions that, when executed by the processor, cause the processor to perform one or more of the operations described herein. The processor can include a general-purpose processor, an application-specific integrated circuit (ASIC), a field-programmable gate array (FPGA), a graphics processing unit (GPU), a tensor processing unit (TPU), etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, read-only memory (ROM), random-access memory (RAM), electronically erasable programmable read-only memory (EEPROM), erasable programmable read-only memory (EPROM), flash memory, optical media, or any other suitable memory from which the processor can read instructions. The instructions can include code from any suitable computer programming language.

Each keymaster system 105 is shown as including a wallet 132, which can store one private seed key 134 (shown here as hierarchical-deterministic (HD) seed keys 134). In some implementations, a keymaster system 105 may maintain or store a single wallet 132. In some implementations, a keymaster system may maintain or store one or more wallets 132. Each keymaster system 105 is shown as locally storing one or more records of DID(s) 136 and one or more records of DID documents 138. In some implementations, DID document(s) 138 may be stored transiently at the keymaster systems 105 (e.g., in performing one or more MDIP operations, data caching, and offline usage), and stored persistently at one or more gatekeeper systems 110, as described in further detail herein. Each keymaster system 105 can manage or maintain multiple agent DID identities; keymaster systems 105 can operate on any software platform, hardware systems, or combinations thereof. The keymaster system 105 includes functionality to create, modify, delete, or otherwise access a MDIP wallet 132 including a private seed key 134, one or more DIDs 136 and/or corresponding DID documents 138, or any other information described in connection with the keymaster system 105 and/or the gatekeeper system 110. Further details of the keymaster 105 are described in further detail herein.

As noted above, each keymaster system 105 implements user and system interfaces to an MDIP wallet 132. Each MDIP wallet 132 can store at least one MDIP seed key 134 used to generate one or more agent DID 161 and their associated unique public key 162. MDIP operations may be provided via one or more graphical user interface 164, command line interfaces 165, APIs 166 and/or native SDK and other function calls 167 of the keymaster 105. The keymaster 105 can generate an MDIP wallet 132 in response to the request by generating a unique private seed that is used to derive a hierarchical-deterministic key-pair 134. In some implementations, the keymaster 105 can generate the seed using cryptographic hashing functions applied to at least one randomly generated number. The cryptographic hashing functions can generate a mnemonic phrase according to the BIP-39 standard, in some implementations. The generated mnemonic can be used to derive a corresponding hierarchical-deterministic key-pair 134, including a public key and a private key for MDIP wallet 132. The wallet's hierarchical-deterministic key-pair 134 may be used to encrypt, decrypt, sign and verify any DIDs 136 or DID documents 138 associated with said wallet. Any suitable deterministic key generation algorithm may be used with the mnemonic to generate MDIP Wallet keys 134, such as elliptic curve cryptography (ECC) techniques. When generated, the wallet 132 can include indications of any associated DIDs 136. An example representation of the wallet 132 in JavaScript Object Notation is provided below:

```
{
  “seed”: {
    “mnemonic”: “P6f40acil4qA1oIHhoK_qNfBPjvdiTn8djxLtcIGMmu5ojQ0g-
fAGLLn33Ix5TavvQTzvc6kXax509bQBZZiXjb7ibTToGyUn0oPeBvSV0RcvHOSXWRmATqIq
d7dpQrdXqWAwVuxeQ3vy95e2NU”,
    “hdkey”: {
      “xpriv”:
“xprv9s21ZrQH143K2x2kGfQ7tgaVHZYQkQVQKbuHgQ4wG7qjfsBoMQD35Ly6rupdEDED1
ZBWKtRGWnjwcf9Wxbyvwn4idCPe1kayCrBoLAp8Hvb”,
      “xpub”:
“xpub661MyMwAqRbcFS7DNgw8FpXDqbNu9sDFgpptUnUYpTNiYfWwtwXHd9HaiD1pEfLt
MGVBKpCR9D6Vtriqkv7co4W72stnzpLdxPRmuLWJUHS”
    }
  },
  “counter”: 0,
  “ids”: { }
}
```

As shown above, an example wallet 132, following generation, includes public (xpub) and private (xpriv) keys 134, in addition to the encrypted mnemonic used to derive MDIP wallet keys 134. In this example, the wallet 132 does not include any DIDs 136, which would be listed in the “ids” list and counted according to the “counter” value. As DIDs 136 and corresponding DID documents 138 are generated as described in further detail herein, these values can be updated in the corresponding wallet 132 used to generate/update the DIDs 136. The keymaster 105 can access various values of the wallet 132 (e.g., MDIP wallet keys 134, DIDs 136, etc.) to perform any of the MDIP operations described herein.

As the MDIP wallet keys 134 are derived deterministically, the mnemonic can be used to recover keys for the wallet 132. The keymaster 105 can re-generate one or more new wallet keys, for example, in response to a corresponding request. In some implementations, a keymaster may only represent one wallet 132 at a time. The request may be provided via one or more client interfaces (e.g., graphical user interface(s) 164, command-line interface(s) 165), API 166, or function calls 167 of the keymaster 105. The request may include the mnemonic in plain text format (e.g., twelve sequential words in plain text). In response to a request to recover a wallet 132, the keymaster 105 can re-generate the MDIP wallet keys 134 using the mnemonic and the same hierarchical-deterministic used to originally derive the MDIP wallet keys 134. In some implementations, a backup of the wallet 132 can be generated by encrypting the current state of the keymaster 105 using the MDIP wallet keys 134 and storing the resulting content in an Asset DID 164 and corresponding DID document 138. MDIP wallet keys 134 re-generated during wallet recovery are used to decrypt the encoded wallet backup from its associated DID document 138 to restore the state of the keymaster system 105.

The keymaster 105 can use the keys 134 of a wallet 132 to generate, modify, or otherwise access one or more DIDs 136. The DIDs 136 can include agent DIDs 161 or asset DIDs 163; both are just a type of DID 136. Agent DIDs 161 include a published unique public key which can be used by third parties to encrypt data to an agent DID 161 and/or validate the digital signature on asset DIDs 163 and their corresponding DID documents 138. Agent DIDs 161 generated by the keymaster 105 can sometimes be referred to herein as “identities” or “IDs,” and may identify a single corresponding user, entity, system, or organization. Agent DIDs 161 generated by the keymaster 105 may not include any personal information and can include the public DID key 162 and a signature proving control of the corresponding private MDIP wallet key 134 by the owner of the agent DID 161 (e.g., the owner of the corresponding wallet 132). The keymaster 105 can generate an agent DID 161, for example, in response to a corresponding request. The request may be provided via one or more interfaces (e.g., the graphical user interface(s) 164, command line interface(s) 165, APIs 166, etc.) or function calls 167 of the keymaster 105, and in some implementations may specify a name or alias for the agent DID 161. Once generated, the agent DID 161 can be stored in association with the name/alias for the agent DID 161 in the keymaster system 105.

To generate an agent DID 161, the keymaster 105 can create an operation object (e.g., a JSON object) that includes various parameters for the agent DID 161. The parameters specified as part of the operation object can include a “type” field set to “create.” The operation object can include a metadata section, designated as “mdip,” identifying that the agent DID 161 is generated according to MDIP. The “mdip” metadata section can include an identification of a registry where any DID 136 is to be recorded (e.g., a decentralized DID registry 120), a version number, and a DID type (in this case, set to “agent”). The keymaster 105 can generate the command operation to include a public DID key 162 in JSON Web Key (JWK) format in a “publicJwk” field. In some implementations, the public DID key 162 associated with the agent DID 161 can be specific to the agent DID 161 and derived from the private MDIP wallet key 134 of the wallet 132 of the keymaster 105 that is to contain the agent DID 161. In some implementations, a timestamp indicating the creation time for the agent DID 161 is included and may be formatted according to ISO 8601 standard. The keymaster 105 can cryptographically sign the operation object using the private MDIP wallet key 134 corresponding to the provided public DID key 162. This signature can be verified, as described in further detail herein, to enable a gatekeeper system 110 to verify the origin and authenticity of the operation object. Once the operation object is generated, the keymaster 105 can transmit or otherwise provide the operation object to a gatekeeper system 110 for permanent storage in the content addressable storage repository 146, distribution to other gatekeepers 110 of a document distribution network 160 via a distribution protocol 172 and registration on immutable blockchain ledgers 130 any confirmation of evidence of the DID 136 on a ledger 130. Further details of the registration process are described herein in connection with the gatekeeper systems 110. An example representation of an operation object to create an agent DID 161 is provided below.

```
{
  “type”: “create”,
  “created”: “2024-03-21T14:17:00.693Z”,
  “mdip”: {
    “registry”: “BTC”,
    “type”: “agent”,
    “version”: 1
  },
  “publicJwk”: {
    “crv”: “secp256k1”,
    “kty”: “EC”,
    “x”: “Mhw_QuIwAqtSC7iGs4a5hTn6o9l3n4e41SVxtwSZHsg”,
    “y”: “PHqyl-KJ74BGYL19Ou-iQ7M-Adn9zKy9xX4wzVPWkcs”
  },
  “signature”: {
    “hash”: “5a2b4280bed5adac087afb0a143b3bcf21c9f140937ed1964eb1106b2f5c4bdf”,
    “signed”: “2024-03-21T14:17:00.703Z”,
    “value”:
“0b087eb5f05cfd3563d56fd1edc2b893b2d27ef096514272f989aabd081d37781a14453e8f36536d3
91c6539d10f6744b4a06ffbf9c559d9383435e278b71554”
  }
}
```

Once created by the gatekeeper system 110, the keymaster 105 can receive the generated agent DID 161 from the gatekeeper system 110. As described in further detail herein, the gatekeeper 110 uses the address of data written to the content addressable storage repository 146 as a unique anchor to generate the DID 136. In some implementations, the CID of the agent DID 161 can be represented in base58btc, and provided as a suffix for the agent DID 161. This process applies equally to asset DIDs 163. An example DID 136 may be represented as follows:
did:mdip:z3v8AuaWjjt2tN9HHtQf8Au9ARZ25zzjkmWmkfVvYDaoM3xcnUP
   In the above representation, “did” indicates that the value is a DID 136, “mdip” indicates that the DID conforms to MDIP described herein, and “z3v8AuaWjjt2tN9HHtQf8Au9ARZ25zzjkmWmkfVvYDaoM3xcnUP” is the suffix CID encoded in base58btc format. Once received from the gatekeeper system 110, the keymaster 105 updates its local storage with corresponding information.

The keymaster 105 can generate one or more asset DIDs 163. Asset DIDs 163 refer to corresponding DID documents 138, which may contain any type of information. Information provided for DID documents 138 associated with asset DIDs 163 are provided during creation/update operations for the asset DID 163. MDIP described herein can be used to implement various types of asset DID 163 structures, including: wallet backups, DID groups, authentication challenge/responses, or a fully verifiable credentials system enabling users to create personalized schemas for peer-to-peer credential attestation between users, systems, entities, or groups. The keymaster 105 can implement a similar process as that above to generate asset DIDs 163.

The keymaster 105 can generate an asset DID 163, for example, in response to a corresponding request. The request may be provided via one or more interfaces (e.g., the graphical user interface(s) 164, command line interface(s) 165, APIs 166, etc.) or function calls 167 of the keymaster 105, and in some implementations may specify a name or alias for the asset DID 163 as well as an indication of the agent DID 161 with which the asset DID 163 is to be associated. To generate an asset DID 163 using MDIP, the keymaster 105 can generate transmit a “create” operation object to a gatekeeper system 110 to add the DID 136 to its local database 144; store the associated DID document 138 in the content addressable storage repository 146; distribute the DID 136 and associated DID document 138 using a document distribution network 160 via a distribution protocol 172 (e.g., a hyperswarm protocol, other peer-to-peer sharing protocols, etc.); and register the new asset DID 163 in a decentralized registry 120. The operation object used to generate the asset DID 163 may be similar to the operation object used to generate one or more agent DIDs 161 but omits the presence of a public key 162. References to DIDs 136 apply to both agent DIDs 161 and asset DIDs 163. For example, the operation object may be a JSON object having one or more parameters similar to those used to generate one or more agent DIDs 161. The operation object for creation of an asset DID 163 can include a parameter that specifies an agent DID 161 as the sole “controller” of the asset DID 163. In one example, the asset DID 163 may be a credential or other identity element that is associated with an agent DID 161, which may represent an identity of an individual user. The operation object for creation of an asset DID 163 can include a parameter specifying that the DID document is to reflect the “asset” type. An example representation of an operation object to create an asset DID 163 is provided below.

```
{
  “type”: “create”,
  “created”: “2024-03-21T18:47:00.655Z”,
  “mdip”: {
    “version”: 1,
    “type”: “asset”,
    “registry”: “BTC”
  },
  “controller”:
“did:mdip:z3v8AuaaBKfwrt2Y7AAbDaGqLNgyn1BDhP7wUFpEMEngmwYwi17”,
  “data”: {
    “credentials”: [ ]
  },
  “signature”: {
    “signer”:
“did:mdip:z3v8AuaaBKfwrt2Y7AAbDaGqLNgyn1BDhP7wUFpEMEngmwYwi17”,
    “signed”: “2024-03-21T18:47:00.729Z”,
    “hash”: “3810490d72e7c912d3213d5d96b4f9c184b347038b385aadc568a6624810b0ef”,
    “value”:
“e80a12d81b9be8a63440203dccb90e954d21b91e862b3fe72d0f306877292b9a5f8e008812561322
25ab39f2cbe9d47012fb4ac32882ac4bfe3bbb49f80efec4”
  }
}
```

In this example, the agent DID 161 of the previous example is controlled by the DID “did:mdip:z3v8AuaaBKfwrt2Y7AAbDaGqLNgyn1BDhP7wUFpEMEngmwYwi17”; the keymaster 105 uses MDIP wallet keys 134 to sign the operation objects for agent DID 161. Once the operation object is generated, the keymaster 105 can transmit or otherwise provide the operation object to a gatekeeper system 110 for storage, distribution, and registration. Further details of the storage, distribution, and registration process are described herein in connection with the gatekeeper systems 110.

The keymaster 105 can update a DID 136 that has been registered by a gatekeeper system 110 according to the techniques described herein. The keymaster 105 can update one or more DIDs 136 in response to corresponding requests. Both agent DIDs 161 and asset DIDs 163 can be updated. The request may be provided via one or more interfaces (e.g., the graphical user interface(s) 164, command line interface(s) 165, APIs 166, etc.) or function calls 167 of the keymaster 105, in some implementations. The request may specify a DID 136 that is to be updated as well as additional document information with which the DID 136 is to be updated. To update a DID 136, the keymaster 105 can generate a corresponding operation object specifying which DID 136 is to be updated and the information with which to update the DID document 138 corresponding to the DID 136.

The operation object to update a DID 136 can include one or more parameters. The parameters can include a “type” set to “update”, a “did” field specifying the DID 136 that is to be updated, a set “doc” information that specifies a new version of a DID document 138, including “didDocument”, “didDocumentMetadata” information, “didDocumentData”, and an “mdip” field specifying MDIP specification for performing the DID operation. The operation object can include a “prev” field specifying a hash (e.g., a SHA256 hash, etc.) of a canonicalized JSON of the previous version of the corresponding DID document 138. Only the controller DID 136 can sign MDIP operation object using the MDIP wallet keys 134 associated with the controller of the DID 136 that is to be updated. Once the operation object is generated, the keymaster 105 can transmit or otherwise provide the operation object to a gatekeeper system 110, causing the gatekeeper system 110 to update the DID document 138 according to the operation object. Further details of the update process are described herein in connection with the gatekeeper system 110. An example representation of an operation object to create an agent DID 136 is provided below.

```
{
  “type”: “update”,
  “did”: “did:mdip:z3v8AuadvRQErtPapNx3ncdUJpPc5dBDGTXXiRxsaH2N8Lj2KzL”,
  “doc”: {
    “@context”: “https://w3id.org/did-resolution/v1”,
    “didDocument”: {
      “@context”: [
        “https://www.w3.org/ns/did/v1”
      ],
      “id”: “did:mdip:z3v8AuadvRQErtPapNx3ncdUJpPc5dBDGTXXiRxsaH2N8Lj2KzL”,
      “verificationMethod”: [
        {
          “id”: “#key-2”,
          “controller”:
“did:mdip:z3v8AuadvRQErtPapNx3ncdUJpPc5dBDGTXXiRxsaH2N8Lj2KzL”,
          “type”: “EcdsaSecp256k1VerificationKey2019”,
          “publicKeyJwk”: {
            “kty”: “EC”,
            “crv”: “secp256k1”,
            “x”: “CkHUpYCLpO-ITepMH8NyR1BinjtC8GEjPZmLbhhvdYQ”,
            “y”: “7tbEsQCgPhMx4vgP7anOZEscV0ruXyaEkyKTXaIMniQ”
          }
        }
      ],
      “authentication”: [
        “#key-2”
      ]
    },
    “didDocumentMetadata”: {
      “created”: “2024-03-25T14:57:20.868Z”
    },
    “didDocumentData”: { },
    “mdip”: {
      “registry”: “BTC”,
      “type”: “agent”,
      “version”: 1
    }
  },
  “prev”: “fb794984f44fe869a75fade8a7bf31ce0f3f46a3eaded4e286769c62f5d9a9ff”,
  “signature”: {
    “signer”: “did:mdip:z3v8AuadvRQErtPapNx3ncdUJpPc5dBDGTXXiRxsaH2N8Lj2KzL”,
    “signed”: “2024-03-25T14:57:26.343Z”,
    “hash”: “575612ed3195eef4e1b7d43b3e40f893d834176321fee8ff6ffe51a79647d912”,
    “value”:
“87571672a51e3558ed9a9d4ef5fcad4dafbf22ee881735e579305b3ebb404ald0891e3b45c8ad5c11
c95e3ae76ca6f2328c87313d58fe80713c0887294d9078a”
  }
}
```

The keymaster 105 can revoke a DID 136 that has been registered by a gatekeeper system 110 according to the techniques described herein. In MDIP, revoking a DID 136 is a type of update that results in termination of the DID 136. Revoked DIDs 136 cannot be updated because they have no current controller (e.g., no associated agent DID 136), therefore they cannot be recovered once revoked. DID documents 138 associated with revoked DIDs 136 can be resolved without error, but the retrieved DID document 138 does not include any document data and includes an indication that the DID document 138 is deactivated. The keymaster 105 can revoke one or more DIDs 136 in response to corresponding requests. The request may be provided via one or more interfaces (e.g., the graphical user interface(s) 164, command line interface(s) 165, APIs 166, etc.) or function calls 167 of the keymaster 105, in some implementations. The request may specify a DID 136 that is to be revoked as well as additional document information with which the DID 136 is to be updated.

To revoke a DID 136, the keymaster 105 can generate a corresponding operation object specifying which DID 136 is to be revoked. The operation object to revoke a DID 136 can specify the “type” parameter as “delete”, a “did” parameter specifying the DID 136 that is to be deleted, a “prev” parameter specifying a hash (e.g., a SHA256 hash, etc.) of a canonicalized JSON of the previous version of the corresponding DID document 138, and a digital signature generated using the MDIP wallet keys 134. Once the operation object is generated, the keymaster 105 can transmit or otherwise provide the operation object to a gatekeeper system 110, causing the gatekeeper system 110 to update the DID document 138 according to the operation object. Further details of the registration process are described herein in connection with the network of gatekeeper systems 110. An example representation of an operation object to revoke a DID 136 is provided below.

```
{
  “type”: “delete”,
  “did”: “did:mdip:z3v8AuagQPwk6WhAjauVgkFCBJfHJBVBmNAYEhDNMBEXEmWQrHr”,
  “prev”: “9f7f0a67b729248c966bb8945cb80320713aa1de42021c88ca849a4ca029f8d7”,
  “signature”: {
    “signer”: “did:mdip:z3v8Auad6fdVkSZE4khWmMwgTjpoMtv82fiT7c56ivNBdjzeMS2”,
    “created”: “2024-02-05T20:00:54.171Z”,
    “hash”: “ff71d0966ee87d827bf3674cb1511c845e18f010186326b3898f336b30e94662”,
    “value”:
“92f95f431729858c79ec4c10824e5aa996b7ae5277ec5143af43baf55c7c8d2f73931be5be46da0a77
95b5c3b773041a91ccc2755857ddfa34758993428e7ad1”
  }
}
```

The keymaster 105 can make requests to one or more gatekeeper systems 110 to resolve one or more DIDs 136. Resolution is the operation of responding to a DID 136 with a DID document 138. Providing such requests to a gatekeeper system 110 can cause the gatekeeper system 110 to access its local database 144 to retrieve the sequence of corresponding DID documents 138 from its content addressable storage repository 146. In some implementations, the requests may specify a particular version of a DID document 138 to retrieve. If provided without a version, the request may indicate that the latest version of the DID document 138 is to be retrieved. A response to the requests may be provided from the gatekeeper system 110 to the keymaster system 105 and may include object data containing the requests DID document 138 data. An example representation of a JSON response including DID document 138 information is provided below:

```
{
  “@context”: “https://w3id.org/did-resolution/v1”,
  “didDocument”: {
    “@context”: [
      “https://www.w3.org/ns/did/v1”
    ],
    “id”: “did:mdip:z3v8AuaYLYSWZJUa4bSadeoiNA3ps8dWDYtsmJNMDJhbFDjaKaX”,
    “controller”:
“did:mdip:z3v8AuaaBKfwrt2Y7AAbDaGqLNgyn1BDhP7wUFpEMEngmwYwi17”
  },
  “didDocumentMetadata”: {
    “created”: “2024-03-21T20:26:01.826Z”
  },
  “didDocumentData”: {
    “$schema”: “http://json-schema.org/draft-07/schema#”,
    “properties”: {
      “account”: {
        “format”: “uri”,
        “type”: “string”
      },
      “service”: {
        “type”: “string”
      }
    },
    “required”: [
      “service”,
      “account”
    ],
    “type”: “object”
  },
  “mdip”: {
    “registry”: “BTC”,
    “type”: “asset”,
    “version”: 1
  }
}
```

In the example above, the DID document 138 is a schema document specifying parameters for a credential, which may be created and verified according to MDIP.

The keymaster 105 may be used to perform additional operations, including but not limited to verification operations, exporting operations, or importing operations. Exporting a DID 136 can include resolving and providing a document specifying an exhaustive history of the DID 136 and associated DID documents 138. Exported DIDs 136 may be provided to other keymaster systems 105 or gatekeeper systems 110 so it can be stored in a content addressable storage repository 146 and processed according to MDIP.

Each gatekeeper system 110 can be or include software, hardware, or any combination thereof. In some implementations, a gatekeeper system 110 may be a computing system that can access functionalities of MDIP by interacting with one or more gatekeeper systems 110. Each gatekeeper system 110 can include one or more processing circuits, which may include at least one processor and a memory (e.g., non-transitory memory). The memory can store processor-executable instructions that, when executed by the processor, cause the processor to perform one or more of the operations described herein. The processor can include a general-purpose processor, an ASIC, an FPGA, a GPU, a TPU, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions can include code from any suitable computer programming language.

Each gatekeeper system 110 is shown as including a DID resolver 142, a local database 144, and a content addressable storage repository 146. The DID resolver 142 and local database 144 may each include software, hardware, or combinations thereof, and may be executed by the gatekeeper system 110 to perform any of the operations described herein. The DID resolver 142 can resolve DIDs 136 into DID documents 138. The gatekeeper 110 can access resources from both the local database 144 and the local content addressable storage repository 146 to perform various operations relating to DIDs 136 and DID documents 138, including but not limited to DID 136 creations, DID 136 updates, DID 136 revocations, and DID 136 resolutions. Although shown as separate from a keymaster system 105, it should be understood that in some implementations, a gatekeeper system 110 and a keymaster system 105 may be executed or otherwise implemented by the same computing system. Further details of the DID resolver 140 are described in further detail herein.

The gatekeeper system 110 is shown as including at least one decentralized storage such as an immutable blockchain ledger or a content addressable storage (CAS) repository 146. The content addressable storage 146 may be maintained according to a decentralized, peer-to-peer file storage and sharing protocol, such as IPFS. The content addressable storage 146 may maintain full records of DID operations on a decentralized blockchain ledger. The content addressable storage repository 146 can implement unique content identifiers to reference DID documents 138 stored in the content addressable storage repository 146. In some implementations, the unique content identifier for a DID document 138 can be used as a unique anchor and become part of its corresponding DID 136. In some implementations, the unique content identifier for a DID document 138 may be derivable from the DID 136 corresponding to the DID document 138. Each gatekeeper 110 can be a node within a decentralized peer-to-peer network that enables access to content hosted on remote content addressable storage 146 systems using a unique content identifier. The gatekeeper 110 can execute various operations to write to or otherwise access information stored in the content addressable storage repository 146, as described in further detail herein.

In one example, the content addressable storage repository 146 can store DID documents 138 corresponding to DIDs 136 using the IPFS protocol. In another example, the content addressable storage repository 146 can store DID Documents 138 in full on a decentralized blockchain. Content addressable storage repositories like IPFS allow content hosted on a remote system to be discovered using the unique content identifiers. MDIP gatekeepers may discover and access addressable content hosted on a remote system using the unique content identifier. As described herein, unique content identifiers are derived from unique cryptographic hashes generated from the corresponding data, and in some implementations may be included as part of the DID 136 corresponding to the DID document 138 stored in the content addressable storage repository 146.

The gatekeeper system 110 can receive requests from one or more keymaster systems 105 to perform various MDIP operations. One example of a request is an operation object to create a DID 136. An example of such a request is described herein in connection with the keymaster system 105. Upon receiving a request to create a DID 136, the gatekeeper system 110 can perform a “create” operation to complete the keymaster 105 request. This may include verifying that the request data includes all necessary fields/parameters, and that the MDIP operation parameters conforms to proper syntax for the requested MDIP operation. For example, when a request indicates an operation to resolve a DID, the gatekeeper system 110 can return the corresponding DID document 138 associated with the DID 136 provided as a parameter to the request.

Prior to performing the operations specified in the MDIP operation request, the gatekeeper 110 may perform various validation and verification on the DID documents 138 associated with the request, including signature verification. As described herein, the MDIP operation request can include a public agent DID key 162 and a digital signature from the associated MDIP wallet keys 134. The public agent DID key 134 may be specified in JWK format, in some implementations. The digital signature included in the MDIP operation request can include a hash value derived from the operation request data itself (e.g., a hash of a JSON file) and a signature value generated by the private MDIP wallet key 134 corresponding to the provided public agent DID key 162. To verify the signature, any gatekeeper 110 can apply the same cryptographic hash function to the signed operation request data to independently compute the hash and use the public agent DID key 162 available from the DID document 138 to confirm that the provided signature corresponds to the computed hash. If the gatekeeper 110 determines that an operation request is invalid (e.g., due to syntax, formatting, incorrect/missing parameters, etc.) or does not include a valid signature, the gatekeeper system 110 may cease processing the operation request and transmit an error message to the keymaster system 105 that provided the operation request. Otherwise, the gatekeeper system 110 can continue to perform the operations of the received request.

To create a DID 136, the gatekeeper system 110 can add the DID 136 to the local database 144 and add the corresponding DID document 138 to the content addressable storage repository 146, resulting in creation of a unique content identifier for the creation request. The resulting unique content identifier, generated according to the content addressable storage repository 146 algorithms can be used to generate the DID 136. As described herein, an example DID 136 may be represented as follows “did:mdip:23v8AuaWjt2tN9HHtQf8Au9ARZ25zzjkmWmkfVvYDaoM3xcnUP,” with the string “z3v8AuaWjjt2tN9HHtQf8Au9ARZ25zzjkmWmkfVvYDaoM3xcnUP” being the unique content identifier from the content addressable storage repository 146. This unique content identifier is used to anchor the content by using the unique identifier as part of the new DID 136. Anchoring content in a content addressable storage repository ensures that the unique document receives a globally unique content address. Once generated, the gatekeeper system 110 can provide the DID 136 to the keymaster system 105 that provided the operation request, completing the creation process.

In some implementations, the gatekeeper system 110 may additionally register a created DID 136 on a decentralized registry 120. A decentralized registry 120 can be a network of blockchain nodes that maintain a blockchain ledger 130. The blockchain ledger 130 maintained by the decentralized registry 120 may be used to record a proof-of-existence of a DID 136. Updates to a DID 136 may also be evidenced on a blockchain ledger 130. The blockchain ledger 130 imposes a strict order on the DID operations, which is important so that all gatekeeper nodes 110 will arrive at the same DID document states without any centralized authority.

Some examples of blockchain ledgers 130 include but are not limited the Bitcoin (BTC) blockchain, the Ethereum (ETH) blockchain, the Binance Smart Chain (BSC) blockchain, the Solana (SOL) blockchain, the Cardano (ADA) blockchain, the Polygon (MATIC) blockchain, the Avalanche (AVAX) blockchain, the Ripple (XRP) blockchain, or the cosmos (ATOM) blockchain), among others. Systems implementing MDIP use these decentralized ledgers as registries 120 by leveraging the network's consensus algorithms and corresponding blockchain ledger 130. Each update to the blockchain ledger 130 following execution of a transaction may provide a transaction confirmation.

Decentralized ledgers will often require users to pay a transaction fee to write a transaction to the ledger. These fees may sometimes be referred to here as “gas” or “transaction” fees. The nodes of the decentralized registry 120 can generate timestamps for transactions by including them in blocks that form an ongoing chain in the blockchain ledger 130. In some implementations, the addition/confirmation of a new block on the blockchain ledger 130 may occur periodically, e.g., approximately every 15 seconds, every minute, every 2.5 minutes or every 10 minutes, etc.). A variety of consensus mechanisms (or protocols) may be used to verify transactions recorded in a blockchain ledger 130. A few non-limiting examples of these consensus mechanisms include proof of work, proof of stake, delegated proof of stake, and proof of authority, among others.

Transactions recorded in the blockchain ledger 130 may include additional data provided by the node requesting inclusion of the transaction in the blockchain ledger 130. The additional data may include metadata or any other data that is compatible with the protocols implemented by the blockchain ledger 130. As described in further detail herein, the gatekeeper systems 110 can use one or more network mediator systems 115 to record indications of new or updated DIDs 136 on a blockchain ledger 130. These indications may include the DIDs 136 themselves and may be included as part of one or more transactions using the network mediator systems 115. The gatekeeper system 110 may provide an indication of the DID 136 to register on the blockchain to a network mediator system 115 corresponding to a decentralized registry 120 identified as the desired “registry” in the operation object.

Each network mediator system 115 can be or include software, hardware, or any combination thereof. In some implementations, a network mediator system 115 may be a computing system that records transactions including one or more DIDs 136 according to MDIP by interacting with one or more gatekeeper systems 110. In some implementations, one or more network mediator systems 115 may be implemented on the same computing system as a gatekeeper system 110 and/or a keymaster system 105. Although shown as separate from any of the decentralized registries 120, it should be understood that in some implementations a network mediator system 115 operate as or may be implemented on a computing system that operates as a node of a decentralized registry 120 to which it corresponds. Although shown as singular elements in FIG. 1, it should be understood that the system 100 may include multiple decentralized registries 120, each with a corresponding blockchain ledger 130 that may implement its own independent protocols or operations. In implementations with multiple blockchain registries 120, multiple network mediator systems 115 can be implemented to coordinate blockchain transactions on the blockchain registries 120. Each network mediator system 115 can operate as a liaison between one or more gatekeeper systems 110 (through which, reach one or more keymaster systems 105) and a corresponding decentralized registry 120. Different network mediator systems 115 can be implemented to interact with different decentralized registries 120, for example, to interface with multiple different types of blockchain networks or other types of registries.

Each network mediator system 115 can include one or more processing circuits, which may include at least one processor and a memory (e.g., non-transitory memory). The memory can store processor-executable instructions that, when executed by the processor, cause the processor to perform one or more of the operations described herein. The processor can include a general-purpose processor, an ASIC, an FPGA, a GPU, a TPU, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions can include code from any suitable computer programming language.

Each network mediator system 115 is shown as including a transaction export loop 148 and a transaction import loop 150. The transaction export loop 148 can instruct a ledger wallet 122 corresponding to a blockchain ledger 130 that enable the network mediator system 115 to sign transactions that are to be exported to the blockchain ledger 130. The ledger keys 152 can include private and public key pairs specific to the network mediator system 115 that enable the network mediator system 115 to digitally sign transactions generated by the transaction export loop 148. The ledger wallet 122 including the ledger keys 152 may be maintained by the network mediator system 115 or by a trusted node in communication with the network mediator system 115. In some implementations, the ledger wallet 122 is a locally controlled sub-system like a hardware cryptocurrency wallet, or any third party cryptocurrency wallet compatible with the blockchain ledger 130. The transaction export loop 148 can receive requests from one or more gatekeeper systems 110 to register one or more DIDs 136 on a blockchain ledger 130.

To improve writing efficiency and to reduce transaction costs, one or more DIDs 136 may be aggregated into a single transaction (e.g., a batch associated with a batch DID). In an example where the Bitcoin blockchain is used, the transaction export loop 148 can generate a Bitcoin transaction instruction for the BTC registry 120 that includes a DID 136, batching any number of other MDIP operation DIDs 136, as the payload of a Bitcoin “OP_RETURN” instruction. In the protocol implemented by the BTC blockchain ledger 130, the “op_return” instruction can be used to specify arbitrary data that is to be registered to the blockchain. Furthering this example, the maximum amount of data that may be written as part of the “op_return” instruction may be 80 bytes of data, which is sufficient for transcribing a DID on the ledger for proof-of-existence registration purposes. In some implementations, the DID Document 138 associated with a DID 136 is recorded in full on the decentralized registry 120 (e.g., the blockchain ledger 130) using blockchain metadata storage methods. The DID Document 138 is provided as the payload of a Bitcoin transaction's segregated witness data within Bitcoin “Opcodes” that can push up to a theoretical 4 Mb of data to the Bitcoin blockchain. In other decentralized registries 120, the space limitation and specific operation codes may differ.

Furthering the example where MDIP operations are registered on the Bitcoin blockchain ledger 130, there can be a time delay during which the MDIP operations have been distributed across Gatekeeper nodes 110 but not yet been included in a block of the blockchain ledger 130. During this block-time period, a DID may be considered usable for selected scenarios, although it has not yet been witnessed on its registry of record. The confirmed state is needed in the scenario where the update includes a change of the keys used for encryption and signature validation. Any number of DIDs 136 may be batched together under a batch DID 136 that can be included or specified in one or more requests to register the DIDs 136 to the blockchain ledger 130.

Blocks that are confirmed according to the protocol of the decentralized registry 120 are added to the blockchain ledger 130. The information added to the blockchain ledger 130 can be included in new blocks generated by miners of the blockchain ledger 130. Once written to the blockchain, the transactions included in the new block become part of a permanent, immutable record in the blockchain ledger 130.

The transaction import loop 150 can receive an indication from one or more nodes of the decentralized registry 120 that a block including evidence of an MDIP operation was written to the blockchain ledger 130. Upon receiving this notification, the transaction import loop 150 can communicate with the decentralized registry 120 to retrieve MDIP operation data witnessed in the decentralized ledger transaction. Such information may include a single DID. Upon receiving the DID witnessed on the decentralized ledger, the network mediator system 115 can provide the blockchain data to the gatekeeper system 110 with an indication that the requested DID(s) 136 were registered to the blockchain ledger 130. DIDs written to the blockchain ledger 130 can include DIDs 136 indicating creation of a DID document 138 and/or DIDs 136 indicating updates/revocation of a DID document 138. DIDs 136 can be resolved to DID documents that contain batches or groups of DIDs 136. In some implementations, the network mediator system 115 may discover complete DID documents 138 recorded on a mediated decentralized registry 120.

Each network mediator system 115 can monitor changes to its corresponding blockchain ledger 130 to identify new DIDs 136 registered in new blocks on the blockchain ledger 130. New DIDs 136 identified from the blockchain ledger 130 can be retrieved/extracted from the blockchain ledger 130 and provided to one or more gatekeeper systems 110. Prior to or while the new DIDs 136 are registered on the blockchain ledger 130, the gatekeeper system 110 can provide the DIDs 136 to other gatekeeper systems 110 using a document distribution network(s) 160 via a distribution protocol 172, such as hyperswarm. Upon receiving a shared DID 136 from another gatekeeper system 110, a gatekeeper 110 can mark or otherwise identify the new DID 136 as unconfirmed until evidence that the new DID 136 has been registered on its registry of record (e.g., a blockchain ledger 130) is witnessed by the remote gatekeeper 110.

The gatekeeper system 110 can receive requests to resolve one or more DIDs 136. The requests may indicate the DID(s) 136 that are to be resolved, and in some implementations may specify a version of the DID document(s) 138 corresponding to the DID(s) 136. Resolving a DID 136 includes returning the latest version of a DID document 138 associated with the DID 136. To resolve a DID 136, the gatekeeper 110 searches its local database 144 for the document. Resolving the DID 136 can include iterating through multiple historical versions of the DID documents 138 associated with the DID 136. In some implementations, a default request to resolve a DID 136 can cause retrieval of the latest (or in some cases specified) version of the DID document 138 from the gatekeeper system 110.

Upon discovery of a new DID 136 using the document distribution network 160, the gatekeeper 110 can access the “registry” field within the initial DID document 138 to identify which registry tracks the updates to the corresponding DID document 138. If the registry is not supported by the gatekeeper system 110 (e.g., the gatekeeper system 110 does not include or is not in communication with a network mediator system 115 corresponding to the specified blockchain ledger 130), the request can, in some implementations, be forwarded to a trusted gatekeeper system 110 capable of mediation with that specific registry.

If the registry is supported, the gatekeeper system 110 updates its local database 144 entry for the DID 136 and stores the MDIP operations that generate the associated DID Document 138 in its local content addressable storage 146. Subsequent update operations heard by the gatekeeper system 110 over the distribution protocol 172 are likewise reflected in the local database 144 and content addressable storage system 146. Each update includes its order sequence, allowing any gatekeeper 110 to preserve the original order of updates. Update records are described in further detail herein.

The DID resolver 142 returns the latest DID document 138 as heard over the distribution protocol 172 in response to the resolution request for the DID 136. When a valid DID 136 update operation is heard by the gatekeeper system 110 over the distribution network 160, the operation is applied to the local database 144 and prior version of the DID document 138 as an unconfirmed update. Configurable settings of the gatekeeper system 110 can specify whether to accept unconfirmed updates or not. The local database 144 will maintain this unconfirmed DID 136 status (e.g., indicated in the “confirmed” field of the document metadata for the corresponding DID document 138) until the gatekeeper system 110 is informed by the mediator system 115 that a DID 136 update operation has been evidenced on the associated DID registry 120. Each gatekeeper system 110 maintains its own local database 144 view of what DIDs 136 have been witnessed on registries 120.

As described herein, DID documents 138 associated with one or more DIDs 136 can be updated in response to a corresponding operation object provided by a keymaster system 105. Updates provided by a keymaster system 105 may be generated based on a previous version of a DID document 138. The gatekeeper system 110 can receive the operation object to update a DID 136 from a keymaster system 105. As described herein, the update operation object can include DID document data, DID document metadata, as well as other fields/data to carry out the update operation. Prior to performing the update operation, the DID gatekeeper 110 can verify that the signature of the update operation object is valid for the controller (e.g., agent DID 136) of the DID 136 to be updated, and that the operation object includes a hash of the previous version of the DID document 138 to which the DID 136 corresponds. The gatekeeper system 110 can resolve the latest version of the DID 136 prior to applying the update, in some implementations, this includes verification of the updated DID document 138 signature/hash. Upon verifying the update operation object, gatekeeper system 110 can store the update operation as an unconfirmed update record in the local database 144 in association with the corresponding DID 136 that is to be updated.

The gatekeeper system 110 can verify the DID document 138 by verifying that it is signed by the controller of the DID at the time the update was created (e.g., using a retrieved public DID key 162 of the controller agent DID 161, as described herein), verifying that the previous version hash in the operation is identical to the hash of the document set that it is updating, and verifying the new DID document 138 version is a valid DID document (e.g., includes proper syntax, formatting, parameters, etc.). If it is determined that the update DID document 138 is invalid for any reason, the update is ignored, otherwise it is applied to the previous document in sequence up to the specified version/resolution time (if specified) or to the end of the sequence (e.g., the latest version, if no version/resolution time is specified). Updates are applied by modifying the data of the DID document 138 to include the information of each update. The resulting DID document 138 is returned to the keymaster system 105 that requested the update operation for the DID 136.

In some implementations, corresponding DID document 138 information for the entire history of DID 136 updates can be stored in the content addressable storage repository 146. The unique identifier of the update record in the content addressable storage repository 146 can be keyed to the DID 136 in the local database 144. In some implementations, the gatekeeper system 110 can update a set of events (e.g., update records) associated with the DID 136 to indicate that the DID has been updated. Each update DID document 138 may be associated with its own respective unique content identifier as generated by the content addressable storage repository 146. Corresponding updated DID document 138 information can be stored in the content addressable storage 146. The DID 136 update operation is marked as unconfirmed until it has been witnessed in decentralized registry 120 in which the DID 136 is to be recorded. The gatekeeper system 110 can include the DID 136 update operation in a separate batch DID document 138 for registration in the decentralized registry 120 in which the DID 136 is to be recorded. The batching process allows any number of DID update operations to be evidenced together in the blockchain ledger 130. In some implementations, DID updates can also be evidenced one-on-one on the blockchain ledger 130.

The gatekeeper system 110 can perform similar operations to carry out revocation operations (e.g., “delete” operations), as described herein, treating the revocation operation as a final update for a specified DID 136. As described herein, revoking a DID 136 results in the termination of the DID 136. Following the revocation, the DID 136 cannot be modified because the DID 136 has no current controller (e.g., an update to revoke removes the controller of the DID 136). The gatekeeper system 110 can resolve a revoked DID 136 using the techniques described herein. However, once revoked, the DID document 138 set retrieved by the gatekeeper system 110 can have the “didMetadata.deactivated” property set to true, as well as the “didDocument” and “didDocumentData” parameters set to empty.

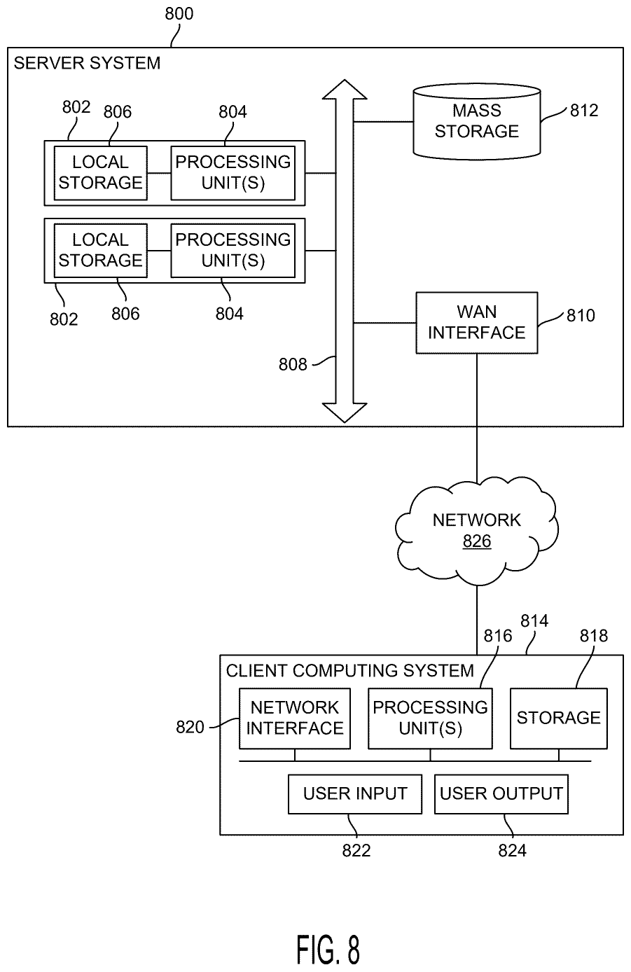

In some implementations, the system 100 may include one or more additional computing systems, servers, mobile devices, or other computing devices similar to those described in connection with FIG. 8 that access or implement any or multiple of the keymaster system 105, the gatekeeper system 110, and the network mediator system 115, to carry out various operations for MDIP. As used herein, MDIP can be used to store and manage verifiable credentials according to schemas. Credentials and schemas can be stored as DID documents 138 and associated with different agent DIDs 136 (e.g., identities). In this manner, MDIP can be used to securely associate and distribute identity information associated with users, systems, groups, or entities in a decentralized manner. MDIP can be used to implement a P2P identity layer with secure decentralized VCs recorded as DID documents 138. An example of an identity credential is provided below.

```
{
  “@context”: [
    “https://www.w3.org/ns/credentials/v2”,
    “https://www.w3.org/ns/credentials/examples/v2”
  ],
  “type”: [
    “VerifiableCredential”,
    “did:test:z3v8AuahaaPcQM4jRmFrNnqNjBZR8bVxePH8ZDTwyANbf9V8peo”
  ],
  “issuer”: “did:test:z3v8AuadCAzcE38LBEsErDWYMPTuTXGbe3FM8W7et6RE8AtUhFx”,
  “validFrom”: “2024-07-19T03:17:24.299Z”,
  “validUntil”: null,
  “credentialSubject”: {
    “id”: “did:test:z3v8AuadCAzcE38LBEsErDWYMPTuTXGbe3FM8W7et6RE8AtUhFx”
  },
  “credential”: {
    “nickname”: “Juno”
  },
  “signature”: {
    “signer”: “did:test:z3v8AuadCAzcE38LBEsErDWYMPTuTXGbe3FM8W7et6RE8AtUhFx”,
    “signed”: “2024-07-19T03:18:26.119Z”,
    “hash”: “c5a60f605bb71c6f27ec2802214ecae4bbde19c36dc5408128e9b800aa00e76c”,
    “value”:
“4fc05b2c362789589f26e3f96a41664b494e0cece6a76ff7a99b37963fb2df4e4b2fdfc85ac725372cc
1c60bd1ce48a44708ad61059768b7e77b2975cd9bd186”
  }
}
```

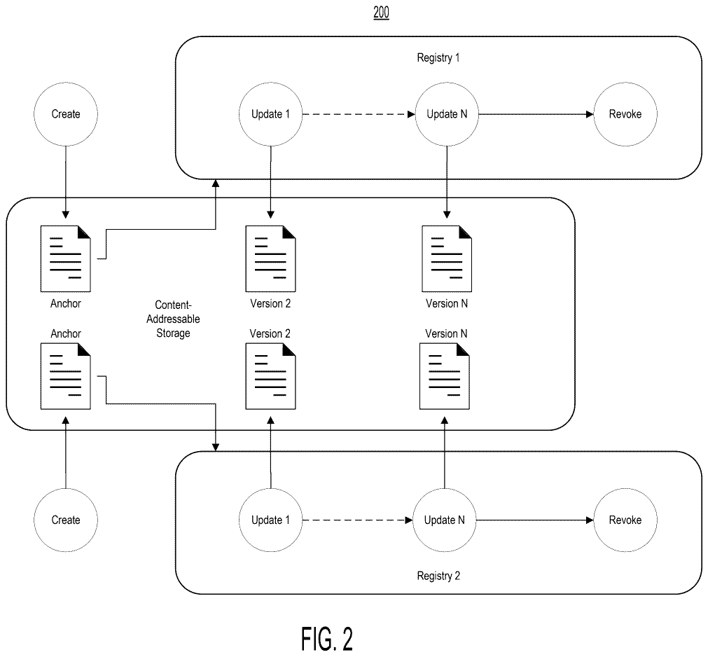

Referring to FIG. 2, illustrated is an example diagram 200 showing how DID documents (e.g., DID documents 138) can be stored and referenced across one or more decentralized registries using MDIP, in accordance with one or more implementations. The diagram 200 shows how DID documents created using a “create” operation object are generated and distributed. As described herein, a “create” operation results in an anchor DID document being written to the content-addressable storage, which identifies a registry at which updates to the DID document are to be recorded/registered. Each update on a registry can point to, or otherwise identify, corresponding DID document data indicating the update, with each next update pointing to the prior update in the chain of updates (e.g., an update event). FIG. 2 illustrates that MDIP-based techniques described herein can be implemented in a registry-agnostic manner, enabling different registries (both immutable and mutable) being able to register changes to DIDs, each DID being associated with a registry of record. Different immutable blockchain-based registries can be implemented to record/register DIDs.

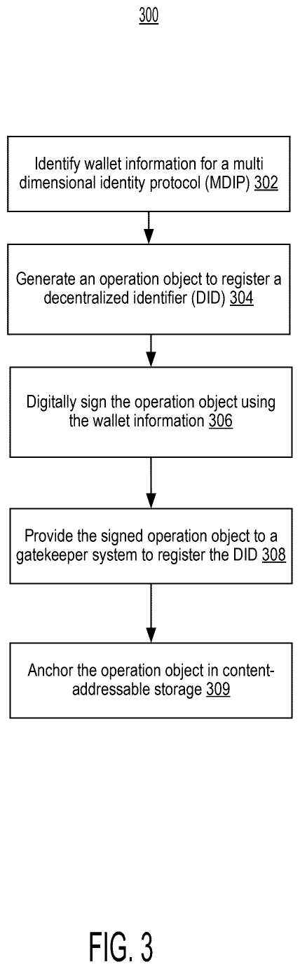

Referring to FIG. 3 in the context of the components described in connection with FIG. 1, illustrated is a flowchart of an example method 300 of generating/creating one or more DIDs using a keymaster system (e.g., the keymaster system 105) implementing MDIP, in accordance with one or more implementations. The method 300 may be performed using any computing device described herein that implements the functionality of a keymaster system 105. The method 300 includes, at step 302, a unique wallet seed used to derive a unique DID key. The method 300 includes, at step 304, generating an operation object to create a decentralized identifier. The method 300 includes, at step 306, digitally signing the operation object using the wallet information. The method 300 includes, at step 308, providing the signed operation object to a gatekeeper system. At step 309, the gatekeeper system anchors the create operation in a content addressable storage and returns the newly created DID to the requesting keymaster.

The method 300 includes, at step 302, identifying wallet information for an MDIP to create a DID. The wallet information can include public and private keys (e.g., MDIP keys 134). In some implementations, the keymaster system can generate a wallet (and any keys associated therewith) by performing operations described in connection with the keymaster system 105. The keys may be a hierarchical-deterministic key-pair derived for the wallet to generate DIDs according to the techniques described herein. In some implementations, the wallet information may be identified in response to a request from a computing device. For example, if the functionality of the keymaster system is implemented by an application executing on a computing device (e.g., a mobile device, etc.), the keymaster system can access wallet information for creating a DID in response to user input at the computing device.

The method 300 includes, at step 304, generating an operation object to create a decentralized identifier. The operation object may be any operation object described herein specifying the “create” type. For example, the operation object may be an operation object to create/register an agent DID. Creating an agent DID may include deriving a new public key 162 for the agent DID to be generated based on the private key included in the identified wallet information. A public key for the agent DID can be included in the create operation object. In another example, the operation object may be an operation object to create/register an asset DID. The operation object for the asset DID can specify an agent DID as a controller and can be signed using the key(s) corresponding to the agent DID. The operation object can specify a registry where the DID is to be registered. Example registries include Bitcoin, Litecoin, or other immutable ledger protocols.

The method 300 includes, at step 306, digitally signing the operation object using the private wallet information. The operation object can be signed by generating a digital signature using the private wallet key from the wallet containing the agent DID to which the operation object corresponds. The public key can be included in the operation object, as described herein, such that the digital signature can be verified by a gatekeeper system. Similar approaches may be implemented when creating asset DIDs, which can be signed using the private wallet key containing the agent DID identified as the controller of the asset DID.

The method 300 includes, at step 308, providing the signed operation object to a gatekeeper system to create and distribute the DID. In some implementations, the signed operation object can be provided via one or more APIs or endpoints of the gatekeeper system. In some implementations, the same computing device that executes the keymaster system is also executing the gatekeeper system, and the signed operation object can be provided via inter-process communication. Once provided to the gatekeeper system, in the case of a create operation, the gatekeeper system stores the DID document in its local content addressable storage, generating a unique content address used to anchor and create the DID. Once the DID is created, the gatekeeper system may distribute the DID to other gatekeeper systems (e.g., of a document distribution network 160 via distribution protocol 172), and responds to the keymaster system with confirmation that the DID was created, stored, distributed, and possibly registered as per the keymaster request. The Keymaster may store the created DID in association with the wallet used to create the operation object. If an error occurs, the keymaster system may provide a notification or message to the user accessing the functionality of the keymaster system.

The method 300, at step 309, the gatekeeper system anchors the create operation in a content addressable storage and returns the newly created DID to the requesting keymaster. The gatekeeper stores the content of the operation object, thereby generating a unique content address that is used to generate the new DID identifier. The unique content address can be used to generate a DID following may correspond to the following nomenclature: did:mdip:{unique content address}. The gatekeeper returns the new DID to the requesting keymaster.

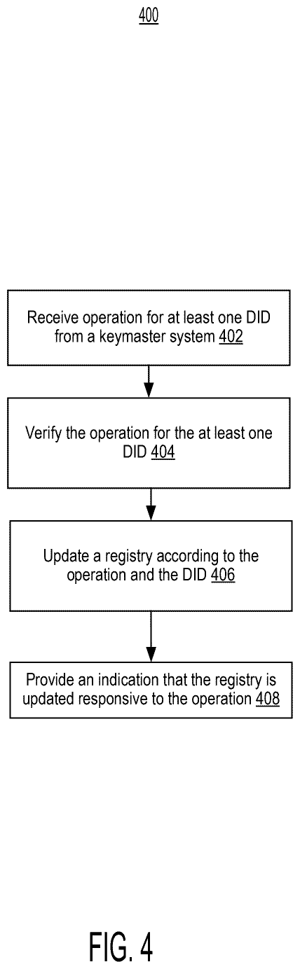

FIG. 4 illustrates a flowchart of an example method 400 of creating and distributing one or more DIDs using a gatekeeper system (e.g., the gatekeeper system 110) implementing MDIP, in accordance with one or more implementations. The method 400 may be performed using any computing device described herein that implements the functionality of a gatekeeper system 110. The method 400 includes, at step 402, receiving an operation for at least one DID from a keymaster system (e.g., a keymaster system 105). The method 400 includes, at step 404, verifying the operation for at least one DID. The method 400 includes, at step 406, updating a registry according to the operation and the DID. The method 400 includes, at step 408, providing an indication that the registry is updated responsive to the operation.

The method 400 includes, at step 402, receiving an operation for at least one DID from a keymaster system (e.g., a keymaster system 105). The operation may be specified via an operation object, as described herein. Examples of operations include create operations, update operations, or revoke operations. The operation may be provided as a JSON object and can include a set of parameters corresponding to the operation. In some implementations, the operation may be received via an API/endpoint of the gatekeeper system. In some implementations, the operation may be received via inter-process communication, for example, when the keymaster system and the gatekeeper system are implemented on the same computing device.

The method 400 includes, at step 404, verifying the operation for the DID. As described herein, the JSON object for the operation can include a digital signature and an indication of a way to verify the digital signature. For example, in a create operation object for an agent DID, a public key (e.g., a public key 162) corresponding to the digital signature can be included in the operation object. In another example for a create or update operation for an asset DID, the public key 162 of the controller (e.g., agent DID 161) of the specified asset DID can be retrieved to verify the digital signature. If the digital signature cannot be verified, the operation can be ignored/dropped, and an error can be returned to the keymaster system. Otherwise, the method 400 can proceed to step 406.

The method 400 includes, at step 406, updating a registry (e.g., a local database 144, local databases 144 of multiple gatekeeper systems of a document distribution network 160 via a distribution protocol 172, a blockchain ledger 130, etc.) according to the operation and the DID. Updating the registry can include storing the operation object corresponding to the operation in a content addressable storage repository (e.g., the content addressable storage 146) to generate unique content identifier for the operation. If the operation is a create operation, the unique content identifier can be an identifier portion of the DID that was created. If the operation is an update operation, the gatekeeper system can store an association between the unique content identifier and the DID that was updated as an update event, such that the up to date DID document data can be resolved using the original DID (e.g., anchor data). Similar operations can be performed for a revoke operation. For a create or update operation, the gatekeeper system can register the DID associated with the unique content identifier in a local database 144 as a new DID or as an update record in a registry identified in the operation object. If the registry is a blockchain-based registry, the gatekeeper system can provide the DID to a network mediator system (e.g., a network mediator system 115) corresponding to the specified blockchain registry. In some implementations, if the gatekeeper system is not in communication with or does not support the specified registry, the gatekeeper node can provide the operation to another gatekeeper system that supports the registry.

The method 400 includes, at step 408, providing an indication that the registry is updated responsive to the operation. Upon receiving an indication that the registry is updated, the gatekeeper system can provide the indication that the operation is completed to the keymaster system. In some implementations, this may include providing a DID to the keymaster system. In some implementations, this may include providing blockchain information (e.g., block index, transaction index, batch index) as part of the DID document associated with the DID.

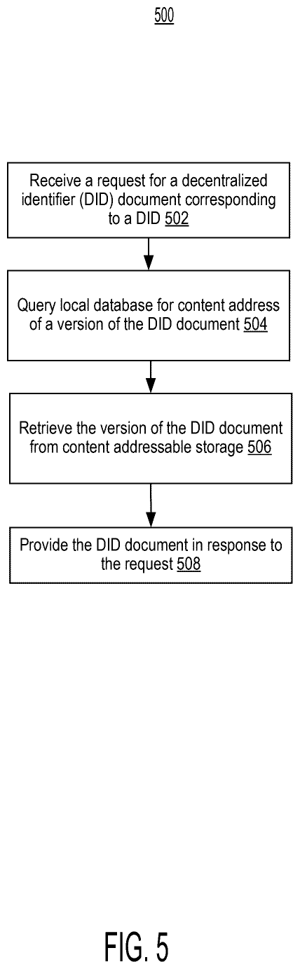

FIG. 5 illustrates a flowchart of an example method 500 of resolving one or more DID documents using a gatekeeper system (e.g., the gatekeeper system 110) implementing MDIP, in accordance with one or more implementations. The method 500 may be performed using any computing device described herein that implements the functionality of a gatekeeper system 110. The method 500 includes, at step 502, receiving a request for at least one DID document corresponding to a DID from a keymaster system (e.g., a keymaster system 105). The method 500 includes, at step 50, identifying the latest known version of a DID document as recorded by the gatekeeper in a database (e.g., a local database 144). The method 500 includes, at step 506, retrieving the latest known DID document based on the unique content address associated to the latest known version as recorded in the local database. The method 500 includes, at step 508, providing the DID document in response to the request.

The method 500 includes, at step 502, receiving a request for at least one DID document corresponding to a DID from a keymaster system (e.g., a keymaster system 105). The request may specify a DID to be resolved, and in some implementations, a time period and/or version for the DID document. In some implementations, the request to resolve the DID may be received via an API/endpoint of the gatekeeper system. In some implementations, the request to resolve the DID may be received via inter-process communication, for example, when the keymaster system and the gatekeeper system are implemented on the same computing device. In some implementations, the request to resolve a DID may be generated from other operations of the gatekeeper system, for example, when resolving public keys for an agent DID to verify one or more digital signatures.

The method 500 includes, at step 504, querying a local database for all sequential MDIP operations for a DID document, including create, update, and revoke operations. The DID document may be reconstructed by following the MDIP operations in the order published and independently confirmed by the mediator witnessing MDIP operations on the registry of record for the DID. The gatekeeper may query the local database for the all known update operations, thereby reconstructing each and up-to-the latest known version of the DID document. The gatekeeper maintains its own local history of update operations received from keymasters or other gatekeepers over the distribution protocol. The gatekeeper's local history may include content addresses for each DID document update, as described herein. If the requested DID is not stored in the local database 144 of the gatekeeper system, the gatekeeper system 110 can forward the request to another gatekeeper system for resolution.

The method 500 includes, at step 506, querying the content addressable storage for the particular version of a DID document based on the content address provided by the local DID database. Content addressable storage may involve communicating with other content addressable storage systems that may preserve a more complete history of DID document versions. The update records can be sorted according to their index number and stored in the local database with associated unique content addresses corresponding to each update operation.

The method 500 includes, at step 508, providing the DID document in response to the request. The DID document may be formatted as a JSON object that is provided to the keymaster system at the API/endpoint in response to the request. If the request was provided via inter-process communication, the gatekeeper system can provide the DID document data via a similar communication mechanism. If any errors occurred during document retrieval/generation, those errors can be provided to the keymaster system using similar approaches.

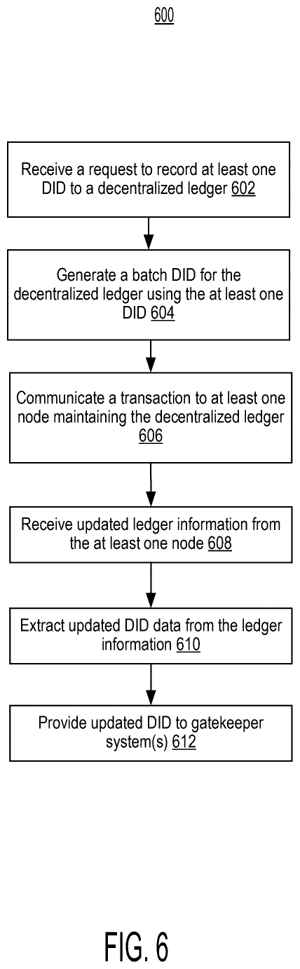

FIG. 6 illustrates a flowchart of an example method 600 to export one or more DIDs into a batch for registration to a decentralized ledger (e.g., a blockchain ledger 130, etc.) according to MDIP, in accordance with one or more implementations. The method 600 may be performed using any computing device described herein that implements the functionality of a network mediator system 115. The method 600 includes, at step 602, a mediator process receiving from a gatekeeper a request to export MDIP operations associated with at least one DID to a decentralized ledger. The method 600 includes, at step 604, generating an export batch grouping any number of MDIP operations for registration. The method 600 includes, at step 606, evidencing the batch DID in a ledger transaction. The method 600 includes, at step 608, witnessing a batch DID in a ledger transaction. The method 600 includes, at step 610, extracting MDIP operations from the imported batch DID. The method 600 includes, at step 612, confirming witnessed MDIP operations with the gatekeeper system(s) (e.g., gatekeeper systems 110).

The method 600 includes, at step 602, receiving a request to register at least one DID to a decentralized ledger (e.g., a blockchain ledger 130). The request can be received from a gatekeeper system and can indicate a DID that is to be registered to the decentralized ledger. In some implementations, the request may specify one or more DIDs containing any number of update documents that are to be registered to the decentralized ledger. The request may batch, for example, multiple DID operations into a single batch DID identifier that is to be registered. In some implementations, the blockchain transaction fees to facilitate registering the DID to the decentralized ledger are provided by the operator of the blockchain ledger. In some implementations, the blockchain transaction can be signed by the user and broadcasted by the operator of the blockchain ledger The decentralized ledger node communicates with other decentralized ledger nodes according to the corresponding decentralized ledger protocol.

The method 600 includes, at step 604, (e.g., during an export loop 148), creating a batch transaction incorporating multiple DID operations into a single batch DID. The single batch DID resolves to a DID document containing any number of MDIP operations that are to be registered on the decentralized ledger. The batch DID can be included in the ledger transaction as “OP_RETURN” data, furthering the example where the decentralized ledger is the Bitcoin blockchain. Other fields may be populated according to corresponding transaction protocols of the specified decentralized ledger, which may not necessarily implement transactions, fees, or cryptocurrency.

The method 600 includes, at step 606, communicating the transaction to at least one node maintaining the decentralized ledger at which the DID is to be registered. In some implementations, the blockchain transaction fees to facilitate registering the DID to the decentralized ledger are provided by the operator of the blockchain ledger. The decentralized ledger node communicates with other decentralized ledger nodes according to the particular decentralized ledger protocol. Once the mediator generates the transaction(s)/request(s), the decentralized ledger system can propagate the transaction(s)/request(s) to the decentralized ledger network according to the decentralized ledger protocol. In some implementations, the node and the network mediator system can be implemented by different computing systems. In some implementations, the node and the network mediator system can be implemented by the same computing system, and the transactions can be provided/specified to the node via inter-process communication.

The method 600 includes, at step 608, during an import loop (e.g., an import loop 150) receiving updated ledger/registry information from the decentralized registry. In an example where the decentralized registry is a blockchain ledger, as blocks are added to the decentralized ledger, the network mediator system can monitor transactions recorded on the decentralized ledger to identify evidence of an MDIP operation on the decentralized ledger. In some implementations, the network mediator system may communicate with one or more nodes maintaining the decentralized ledger to request the updated ledger information (e.g., new blocks and associated data).

The method 600 includes, at step 610, extracting updated DID data from the ledger transaction. For example, the network mediator system can discover, from the ledger transaction data, possible evidence of MDIP operations. Upon identifying a transaction having an MDIP batch DID, the network mediator system can of the extract the information in addition to metadata indicating where the extracted DID information is stored on the decentralized ledger (e.g., block index, transaction index, batch index, etc.). The extracted information may specify additional MDIP or DID data, in some implementations.

The method 600 includes, at step 612, providing the witnessed DIDs data to gatekeeper system(s) (e.g., gatekeeper systems 110). Upon identifying new DID data recorded to the decentralized ledger, the network mediator system can provide the extracted DID data, including indications of where the extracted DID information is stored on the decentralized ledger. The indications may include metadata indicating when the DID information was recorded to the decentralized ledger. The updated DID data can be provided via one or more APIs/endpoints of the gatekeeper system or via inter-process communication, in some implementations.

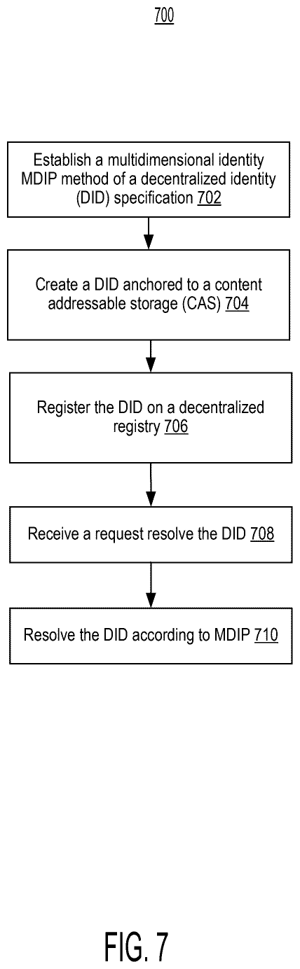

FIG. 7 illustrates a flowchart of an example method 700 to for creating and managing one or more DIDs according to MDIP, in accordance with one or more implementations. The method 700 may be performed using any computing device described herein, for example, any computing that can implement the functionality of the gatekeeper system 110 of FIG. 1. The method 700 includes, at step 702, establishing an MDIP method of a DID specification. The method 700 includes, at step 704, creating a DID anchored to a CAS. The method 700 includes, at step 706, registering the DID on a decentralized registry. The method 700 includes, at step 708, receiving a request to resolve the DID. The method 700 includes, at step 710, resolving the DID according to MDIP.

In further detail, the method 700 includes, at step 702, establishing an MDIP method of a DID specification. The MDIP DID method can provide a P2P identity layer with secure decentralized verifiable credentials. Establishing an MDIP method of the DID specification may include initializing (e.g., via configuration settings, suitable interfaces, etc.) a gatekeeper system to enable the gatekeeper system to perform any of the MDIP operations described herein. In one example, the gatekeeper system may be initialized by loading configuration data, which may include accessing APIs and/or other interfaces for various registries (e.g., decentralized registries, etc.) or storage systems (e.g., CAS, etc.). In some implementations, the gatekeeper system may access one or more libraries, functions, or components that facilitate peer-to-peer networking, cryptographic construction of decentralized identifiers, and/or any other operations that support the MDIP operations described herein.

In some implementations, the gatekeeper system may initialize at least a portion of a peer-to-peer content addressable storage (e.g., a document distribution network 160 such as an IPFS system, etc.) that may be used at least in part to storage various DID documents or other data described herein. In implementations where the gatekeeper system operates as a node of a decentralized registry (e.g., decentralized registry 120, etc.), the gatekeeper system may communicate with other nodes of the decentralized registry to access up-to-date blocks and/or to facilitate operations of the decentralized registry. During initialization, the gatekeeper system may communicate with other gatekeeper systems and/or keymaster systems (e.g., keymaster systems 105) to receive updates to metadata or any other data described herein. Establishing the MDIP method of the DID specification may include performing any of the operations of the gatekeeper system 110 of FIG. 1.

The method 700 includes, at step 704, creating a DID (e.g., a DID 136) anchored to a CAS (e.g., a content addressable storage repository 146). The DID can include at least part of a unique identifier provided by the CAS and derived from an MDIP DID create operation for a document (e.g., a DID document 138). To do so, any of the operations of the gatekeeper system 110 of FIG. 1 may be performed. The DID can be created, for example, in response to receiving a corresponding MDIP DID create operation document from a keymaster system, as described herein. Such create operation documents may be generated, for example, using the techniques described in connection with the method 300 of FIG. 3. Creating a DID anchored to the CAS may include performing any of the operations described in connection with the method 400 of FIG. 4.

The DID may be an agent DID or an asset DID. The DID document can identify an agent DID as a controller of the DID document. The document may be an asset DID document, which may have or may not have an associated public key. Creating a DID anchored to the CAS system can include invoking a cryptographic hash function of the CAS to generate a unique content identifier for the corresponding DID document, as described herein. The content identifier can be included as part of the MDIP DID used to identify the document in the CAS. The resulting DID may thereby reference the CAS address for the corresponding DID document. The gatekeeper system can be a node within a decentralized peer-to-peer network that enables access to content hosted on the CAS system by multiple gatekeeper systems.

The method 700 includes, at step 706, registering the DID on a decentralized registry (e.g., the decentralized registry 120, the blockchain ledger 130, etc.). As the DID can include a unique identifier of the corresponding DID document in the CAS, the DID registered on the decentralized registry can immutably identify a pointer to the document of the DID in the CAS. In some implementations, the DID document and/or the request to create the DID can indicate the registry in which the DID is to be anchored. Registering the DID on the decentralized registry can involve performing any of the operations of the gatekeeper system 110 of FIG. 1, and/or performing any of the operations of the method 600 of FIG. 1. For example, registering the DID on the decentralized registry can include communicating with a network mediator system (e.g., a network mediator system 115).

In various implementations, the gatekeeper system or the network mediator system can communicate with nodes of the decentralized registry (e.g., a blockchain network, etc.) to register the DID. For example, the gatekeeper system or the network mediator system can transmit a transaction to the nodes of the decentralized registry in which the DID is to be registered. The transaction may include or indicate the DID in metadata of the transaction. In some implementations, the gatekeeper system can distribute the DID and/or DID document across an MDIP network of MDIP gatekeeper systems (e.g., using a suitable document distribution network 160 and/or document distribution protocol 172, etc.) without waiting for registration of the DID on the decentralized registry. For example, the gatekeeper system may communicate the DID and/or DID document associated therewith via the distribution network at the same time as communicating the DID for registration on the decentralized registry. The DID and/or DID document may be distributed via the MDIP network of gatekeepers faster than registration of the DID on the decentralized registry.

Once communicated, the network mediator system (e.g., via the import loop 150) or the gatekeeper system can monitor a status of the decentralized registry to witness the transaction including the DID, to confirm that the DID has been registered to the blockchain. In some implementations, the gatekeeper system can obtain information relating to the location (e.g., block identifier, timestamp, etc.) of the registered DID in the decentralized registry, and can store an association between the transaction location and the DID in a local database (e.g., local database 144, etc.). In some implementations, the gatekeeper system may communicate the keymaster system that requested creation and registration of the DID, as described herein.

The method 700 includes, at step 708, receiving a request to resolve the DID. To do so, any of the operations of the gatekeeper system 110 of FIG. 1 may be performed. Resolving the DID may include performing any of the operations described in connection with the method 500 of FIG. 5. The request to resolve a DID may be received, for example, from a keymaster system using a suitable API call to the gatekeeper system. In some implementations, the resolution request may specify a version of the DID document to resolve. For example, keymaster system may transmit a request to the gatekeeper that specifies the MDIP DID corresponding to the document (which was previously registered in the decentralized registry) with an identifier of the document version to the gatekeeper system.

The method 700 includes, at step 710, resolving the DID according to MDIP. To do so, any of the operations of the gatekeeper system 110 of FIG. 1 may be performed. Resolving the DID may include performing any of the operations described in connection with the method 500 of FIG. 5. Resolving the DID can be performed in response to receiving the request to resolve the DID at step 708. To resolve the DID, in some implementations, the gatekeeper system can use the content identifier included in the DID to retrieve the corresponding DID document from the CAS system. In some implementations, the gatekeeper can query a local database for the all known update operations associated with the DID to be resolved, in order to reconstruct the requested version (or if not provided, the latest version) of the DID document. As described herein, the gatekeeper can maintain a local history of update operations received from keymasters or other gatekeepers over the distribution protocol. Once retrieved from the CAS system, the gatekeeper system can provide the DID document to the requesting keymaster system in response to the request. If the DID document cannot be retrieved (e.g., the CAS system provides an error, the DID document has been deleted, etc.), the gatekeeper system can transmit an indication that the DID cannot be resolved to the keymaster system.

Various operations described herein can be implemented on computer systems. FIG. 8 shows a simplified block diagram of a representative server system 800, client computer system 814, and network 826 usable to implement certain implementations of the present disclosure. In various implementations, server system 800 or similar systems can implement services or servers described herein or portions thereof. Client computer system 814 or similar systems can implement clients described herein. The system and others described herein can be similar to the server system 800.

Server system 800 can have a modular design that incorporates a number of modules 802; while two modules 802 are shown, any number can be provided. Each module 802 can include processing unit(s) 804 and local storage 806.

Processing unit(s) 804 can include a single processor, which can have one or more cores, or multiple processors. In some implementations, processing unit(s) 804 can include a general-purpose primary processor as well as one or more special-purpose co-processors such as graphics processors, digital signal processors, or the like. In some implementations, some or all processing units 804 can be implemented using customized circuits, such as ASICs or FPGAs. In some implementations, such integrated circuits execute instructions that are stored on the circuit itself. In other implementations, processing unit(s) 804 can execute instructions stored in local storage 806. Any type of processors in any combination can be included in processing unit(s) 804.

Local storage 806 can include volatile storage media (e.g., DRAM, SRAM, SDRAM, or the like) and/or non-volatile storage media (e.g., magnetic or optical disk, flash memory, or the like). Storage media incorporated in local storage 806 can be fixed, removable or upgradeable as desired. Local storage 806 can be physically or logically divided into various subunits such as a system memory, a read-only memory (ROM), and a permanent storage device. The system memory can be a read-and-write memory device or a volatile read-and-write memory, such as dynamic random-access memory. The system memory can store some or all of the instructions and data that processing unit(s) 804 need at runtime. The ROM can store static data and instructions that are needed by processing unit(s) 804. The permanent storage device can be a non-volatile read-and-write memory device that can store instructions and data even when module 802 is powered down. The term “storage medium” as used herein includes any medium in which data can be stored indefinitely (subject to overwriting, electrical disturbance, power loss, or the like) and does not include carrier waves and transitory electronic signals propagating wirelessly or over wired connections.

In some implementations, local storage 806 can store one or more software programs to be executed by processing unit(s) 804, such as an operating system and/or programs implementing various server functions such as functions of the various systems/components of FIG. 1 or any other system described herein, or any other server(s)/computing devices associated with the keymaster systems 105, gatekeeper systems 110, network mediator systems 115, or any other system described herein.

“Software” refers generally to sequences of instructions that, when executed by processing unit(s) 804 cause server system 800 (or portions thereof) to perform various operations, thus defining one or more specific machine implementations that execute and perform the operations of the software programs. The instructions can be stored as firmware residing in read-only memory and/or program code stored in non-volatile storage media that can be read into volatile working memory for execution by processing unit(s) 804. Software can be implemented as a single program or a collection of separate programs or program modules that interact as desired. From local storage 806 (or non-local storage described below), processing unit(s) 804 can retrieve program instructions to execute and data to process in order to execute various operations described above.

In some server systems 800, multiple modules 802 can be interconnected via a bus or other interconnect 808, forming a local area network that supports communication between modules 802 and other components of server system 800. Interconnect 808 can be implemented using various technologies including server racks, hubs, routers, etc.

A wide area network (WAN) interface 810 can provide data communication capability between the local area network (interconnect 808) and the network 826, such as the Internet. Technologies can be used, including wired (e.g., Ethernet, IEEE 802.3 standards) and/or wireless technologies (e.g., Wi-Fi, IEEE 802.11 standards).

In some implementations, local storage 806 is intended to provide working memory for processing unit(s) 804, providing fast access to programs and/or data to be processed while reducing traffic on interconnect 808. Storage for larger quantities of data can be provided on the local area network by one or more mass storage subsystems 812 that can be connected to interconnect 808. Mass storage subsystem 812 can be based on magnetic, optical, semiconductor, or other data storage media. Direct attached storage, storage area networks, network-attached storage, and the like can be used. Any data stores or other collections of data described herein as being produced, consumed, or maintained by a service or server can be stored in mass storage subsystem 812. In some implementations, additional data storage resources may be accessible via WAN interface 810 (potentially with increased latency).

Server system 800 can operate in response to requests received via WAN interface 810. For example, one of modules 802 can implement a supervisory function and assign discrete tasks to other modules 802 in response to received requests. Work allocation techniques can be used. As requests are processed, results can be returned to the requester via WAN interface 810. Such operation can generally be automated. Further, in some implementations, WAN interface 810 can connect multiple server systems 800 to each other, providing scalable systems capable of managing high volumes of activity. Techniques for managing server systems and server farms (collections of server systems that cooperate) can be used, including dynamic resource allocation and reallocation.

Server system 800 can interact with various user-owned or user-operated devices via a wide-area network such as the Internet. An example of a user-operated device is shown in FIG. 8 as client computing system 814. Client computing system 814 can be implemented, for example, as a consumer device such as a smartphone, other mobile phone, tablet computer, wearable computing device (e.g., smart watch, eyeglasses), desktop computer, laptop computer, and so on.

For example, client computing system 814 can communicate via WAN interface 810. Client computing system 814 can include computer components such as processing unit(s) 816, storage device 818, network interface 820, user input device 822, and user output device 424. Client computing system 814 can be a computing device implemented in a variety of form factors, such as a desktop computer, laptop computer, tablet computer, smartphone, other mobile computing device, wearable computing device, or the like.

Processor 816 and storage device 818 can be similar to processing unit(s) 804 and local storage 806 described above. Suitable devices can be selected based on the demands to be placed on client computing system 814; for example, client computing system 814 can be implemented as a “thin” client with limited processing capability or as a high-powered computing device. Client computing system 814 can be provisioned with program code executable by processing unit(s) 816 to enable various interactions with server system 800 of a message management service such as accessing messages, performing actions on messages, and other interactions described above. Some client computing systems 814 can also interact with a messaging service independently of the message management service.

Network interface 820 can provide a connection to the network 826, such as a wide area network (e.g., the Internet) to which WAN interface 810 of server system 800 is also connected. In various implementations, network interface 820 can include a wired interface (e.g., Ethernet) and/or a wireless interface implementing various RF data communication standards such as Wi-Fi, Bluetooth, or cellular data network standards (e.g., 3G, 4G, LTE, etc.).

User input device 822 can include any device (or devices) via which a user can provide signals to client computing system 814; client computing system 814 can interpret the signals as indicative of particular user requests or information. In various implementations, user input device 822 can include any or all of a keyboard, touch pad, touch screen, mouse or other pointing device, scroll wheel, click wheel, dial, button, switch, keypad, microphone, and so on.

User output device 824 can include any device via which client computing system 814 can provide information to a user. For example, user output device 824 can include a display to display images generated by or delivered to client computing system 814. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some implementations can include a device such as a touchscreen that function as both input and output device. In some implementations, other user output devices 824 can be provided in addition to or instead of a display. Examples include indicator lights, speakers, tactile “display” devices, printers, and so on.

Some implementations include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 804 and 816 can provide various functionality for server system 800 and client computing system 814, including any of the functionality described herein as being performed by a server or client, or other functionality associated with message management services.

It will be appreciated that server system 800 and client computing system 814 are illustrative and that variations and modifications are possible. Computer systems used in connection with implementations of the present disclosure can have other capabilities not specifically described here. Further, while server system 800 and client computing system 814 are described with reference to particular blocks, it is to be understood that these blocks are defined for convenience of description and are not intended to imply a particular physical arrangement of component parts. For instance, different blocks can be but need not be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, e.g., one or more components of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of these. Moreover, while a computer storage medium is not a propagated signal, a computer storage medium can include a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The terms “data processing apparatus”, “data processing system”, “client device”, “computing platform”, “computing device”, or “device” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of these. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA or an ASIC.

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer include a processor for performing actions in accordance with instructions and one or more memory devices for storing instructions and data. Generally, a computer will also include, or be operatively coupled to receive data from or transfer data to, or both, one or more mass storage devices for storing data. However, a computer need not have such devices. Moreover, a computer can be embedded in another device, e.g., a smartphone, a mobile telephone, a personal digital assistant (PDA), a game console, a Global Positioning System (GPS) receiver, or a portable storage device (e.g., a universal serial bus (USB) flash drive), for example. Devices suitable for storing computer program instructions and data include all forms of non-volatile memory, media, and memory devices, including by way of example semiconductor memory devices, e.g., EPROM, EEPROM, and flash memory devices. The processor and the memory can be supplemented by, or incorporated in, special purpose logic circuitry.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a LAN and a WAN, an inter-network (e.g., the Internet), and peer-to-peer networks (e.g., ad hoc peer-to-peer networks).

The computing system such as the keymaster systems, gatekeeper systems, network mediator systems, or nodes of decentralized registries described herein can include clients and/or servers. For example, the keymaster systems, gatekeeper systems, network mediator systems, or nodes of decentralized registries can include one or more servers in one or more data centers or server farms. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving input from a user interacting with the client device). Data generated at the client device (e.g., a result of an interaction, computation, or any other event or computation) can be received from the client device at the server, and vice-versa.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the keymaster systems, gatekeeper systems, network mediator systems, or nodes of decentralized registries could be a single module, a logic device having one or more processing modules, one or more servers, or part of a search engine.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations, elements, or acts of the systems and methods herein referred to in the singular may also embrace implementations including a plurality of these elements; and any references in plural to any implementation, element, or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description, or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. Although the examples provided may be useful for providing/implementing an MDIP, the systems and methods described herein may be applied to other environments. The foregoing implementations are illustrative, rather than limiting, of the described systems and methods. The scope of the systems and methods described herein may thus be indicated by the appended claims, rather than the foregoing description, and changes that come within the meaning and range of equivalency of the claims are embraced therein.

What is claimed is:

1. A method comprising:
establishing, by one or more processors coupled to non-transitory memory, a multidimensional identity protocol (MDIP) method of a decentralized identifier (DID) specification, the MDIP DID method configured to provide a peer-to-peer identity layer with secure decentralized verifiable credentials;
creating, by the one or more processors, a DID anchored to a content addressable storage (CAS), the DID comprising a part of a unique identifier provided by the CAS and derived from an MDIP DID create operation for a document;
registering, by the one or more processors, the DID on a decentralized registry, the DID identifying a pointer to the document of the DID in the CAS; and
receiving, by the one or more processors, a request to resolve the DID.

2. The method of claim 1, further comprising anchoring, by the one or more processors, the DID to the CAS prior to registering the DID on the decentralized registry.

3. The method of claim 2, wherein the document corresponding to the DID anchored in the CAS identifies the decentralized registry.

4. The method of claim 1, wherein the document associated with the DID comprises an indication of one of an agent or an asset.

5. The method of claim 4, wherein the document identifies a single agent as a controller.

6. The method of claim 4, wherein the asset does not have an associated public key.

7. The method of claim 1, wherein the DID and the document are provided to a distribution network to distribute the DID and the document across a plurality of MDIP nodes of a network without waiting for registration of the DID on the decentralized registry.

8. The method of claim 7, wherein the DID is distributed to the plurality of MDIP nodes one of prior to completion of registration of the DID on the decentralized registry or faster than registration of the DID on the decentralized registry.

9. The method of claim 1 further comprising identifying, by the one or more processors responsive to monitoring the decentralized registry, an update to the document associated with the DID, the decentralized registry storing for each update to the document a corresponding pointer to a corresponding version of the document in the CAS.

10. The method of claim 1, wherein creating the DID is decentralized through the CAS and an update to the document of an DID is decentralized through the decentralized registry.

11. The method of claim 1, wherein the DID is identified as an agent DID, and the document comprises a public key and specifies the agent DID as a controller.

12. A system, comprising:
one or more processors coupled to memory, the one or more processors configured to:
identify a wallet for a multidimensional identity protocol, the wallet comprising a private key and a public key corresponding to the private key;
generate, using information of the wallet, an operation object to register a decentralized identifier (DID) for the wallet in a decentralized registry, the operation object comprising the public key;
digitally sign the operation object using the private key; and
provide the operation object to a gatekeeper system, causing the gatekeeper system to verify the operation object using the public key and record the DID in the decentralized registry.

13. The system of claim 12, wherein the one or more processors are further configured to:
derive the private key and the public key in response to a request to generate the wallet.

14. The system of claim 12, wherein the operation object identifies one of a create operation, an update operation, or a delete operation.

15. A system, comprising:
one or more processors coupled to memory, the one or more processors configured to:
receive, from a keymaster system, an operation object to register a decentralized identifier (DID) in a decentralized registry, the operation object comprising a public key and a digital signature purportedly generated using a private key corresponding to the public key;
verify the digital signature of the operation object using the public key;
update a decentralized registry based on the operation object to generate the DID; and
provide the DID to the keymaster system in response to the operation object.

16. The system of claim 15, wherein the one or more processors are further configured to:
derive the DID based on a content identifier of a content addressable storage (CAS) system.

17. The system of claim 15, wherein the one or more processors are further configured to:
monitor the decentralized registry to witness the DID.

18. A system, comprising:
one or more processors coupled to memory, the one or more processors configured to:
receive, from a keymaster system, a request to access document stored in a decentralized registry, the request comprising a decentralized identifier (DID) of the document;
retrieve anchor data identified by the DID from a database;
generate the document using information retrieved from a decentralized registry identified in the anchor data; and
provide the document in response to the request.

19. The system of claim 18, wherein the one or more processors are further configured to:
generate the document based on at least one update document associated with the anchor data identified by the DID.

20. The system of claim 19, wherein the update document indicates that the DID has been deleted.
